(19) United States
(12) Patent Application Publication
(10) Pub. No.: US 2010/0035210 A1
(43) Pub. Date: Feb. 11, 2010

(54) Method for Producing a Dental Product, and Scannable Material

(75) Inventors: Matthias Suchan, Hachenburg (DE); Alexander Bublewitz, Herborn (DE); Jens-Peter Reber, Meinerzhagen (DE)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: KETTENBACH GMBH & CO. KG, Eschenburg (DE)

(21) Appl. No.: 12/516,759

(22) PCT Filed: Nov. 28, 2007
(86) PCT No.: PCT/EP07/10311

§ 371 Date: Oct. 22, 2009

(30) Foreign Application Priority Data
Nov. 28, 2006 (DE) 102006056451.0

(51) Int. Cl. A61C 13/003; A61C 9/00

(52) U.S. Cl. 433/201.1; 433/214

(57) ABSTRACT

The invention concerns a method for the production of a dental product, whereby the impression of a negative mold of at least one tooth or one tooth stump is created with an impression material, and this negative mold is scanned. By using the scan results, the dental product is then mechanically produced.

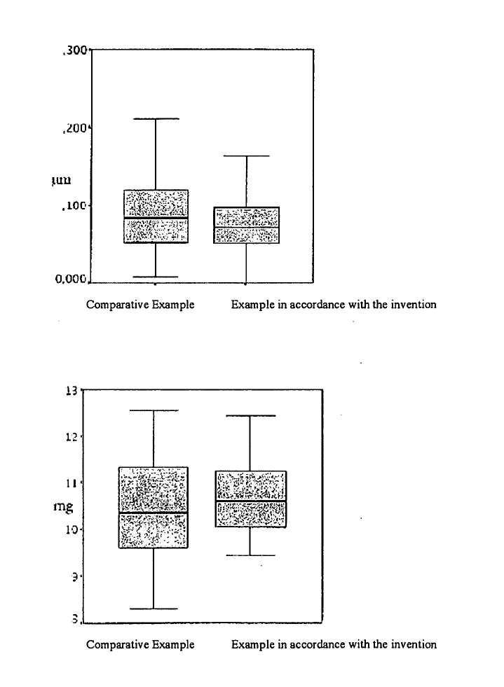

The invention concerns a method for producing a dental product, for example, a crown or a bridge, whereby at first a mold of at least one tooth or tooth stump is created with an impression material and subsequently the dental product is mechanically produced. Further, the invention concerns an impression material which is suitable for such a procedure.

The production of dental products with CAD and/or CAM processes is known in dentistry. For this purpose there is, for example, the CEREC 3 System®, a camera system made by Sirona Dental Systems GmbH, with which the intraoral tooth configuration can be captured after grinding a tooth and with the data captured hereby, a dental product can be produced mechanically. Independent thereof, in the mouth of the patient—based on the crowded space, scanning of a tooth configuration is perceived as being difficult to some extent—with this system, the surface of the prepared tooth, as well as the neighboring teeth must be optimized with a white powder spray in order to obtain a scan result that is sufficient. Thereby, problems occur to some extent, as even the smallest amounts of moisture change the surface of the powder layer and additionally, injecting cavities in molars can be difficult. In particular, these sources of error can cause an impairment of the margin fit of a restoration as a consequence.

In DE 103 39 247 A1, a method for the production of a dental restoration is suggested in which an impression of a mouth configuration is scanned as a negative mold without making a positive model available, whereby the scan result is used for the mechanical production of the dental restoration. The mechanical scanning of this negative mold is perceived to be disadvantageous, particularly in the area of undercutting. Even when optically scanning the negative mold, often not enough information for the exact reproduction of all details can be obtained. Especially the capture of edges and unfavorable angles is difficult in optical scanning. Optical scanning is therefore perceived as being in need of improvement.

In order to scan or capture the mold optically as exactly as possible, in DE 100 38 564 A1, a mass for the production of the mold is suggested, which is mixed with a metal powder, a powder of a metal alloy or a powder of a pigment with metallic effect is mixed in. It has however been shown that even when using such a mass, the scan results were found to be unsatisfactory in part, as an exact reproduction is not always possible. Moreover, this material is suitable only for impressions in the range of approximately 1 to 2 mm that are used, for example, for bite registration.

Compared to that, the present invention is based on the problem of making a method available, as well as making the impression material to be used available, which can be handled well and makes a reproducible dental product of high quality and precision available, by using scan results.

According to the invention, this problem is essentially solved thereby, that in a method of the type mentioned at the beginning, at least a part of the surface of the mold of a tooth or tooth stump is roughened, before the roughened impression is scanned with the negative mold and then the dental product is mechanically produced using the scan results. Thereby, the invention is based on the idea that the roughening of the surface of the impression leads to a matting that improves the scan result significantly. In this manner, impressions having a depth of over 2 mm can also be scanned well and dental products can be produced by using scan results with high precision.

According to a preferred embodiment of the invention, the roughening of the surface of the impression is made by laser irradiation, splatter procedures, evaporation, plasma procedures, sand blasting and/or powder jet procedures. Sand blasting is a procedure in which, for example, rough quartz sand is sprayed onto the negative mold with compressed air. In contrast to that, in a powder jet procedure, fine sand, for example, sodium bicarbonate is sprayed on in order to achieve a roughening of the surface of the impression for improved scannability. Sand blasting as well as the powder jet procedure have the advantage that devices of such types are available in the laboratory or at the dental office, so that no additional investments are required in a dental practice. A dentist consequently is also not required to learn any new procedures. Particularly, devices for the powder jet procedure, with which coverings of a tooth are usually removed, are most often available at each treatment chair in a dental practice.

For the method according to the invention, mechanical scanning is suitable, as well as contact-free scanning of the roughened impression. However, it is preferred that the scanning of the roughened impression is performed contact-free. This can happen, for example, by laser scanning, by stripe projection or with a CCD camera. It is particularly preferred to perform the contact-free scanning with the above mentioned CEREC 3 System® made by Sirona Dental Systems GmbH, whereby the software which is usually used for scanning a positive mold is adapted to the method according to the invention in order to scan impressions, i.e. a negative mold instead of projecting points.

For the production of a crown or a bridge as a dental product it is preferred, when the at least one tooth or tooth stump is molded only after being ground, i.e. after the preparation and this negative mold is roughened and subsequently scanned. Alternatively, it is however also possible that first, an impression is made of the original tooth configuration, the data of which is used for producing the outer contour of the dental product, while after preparation an additional impression is made, the data of which is used for producing the inner contour of the dental product.

Particularly for badly destroyed teeth, it does not make sense to make an impression of the original tooth configuration. In such cases, by taking the results of the scan into consideration, a sample is selected from a database, especially a picture database, and this is used in conjunction with the scan result for the production of the dental product.

The mechanical production of the dental product then preferably takes place in a CAD and/or CAM procedure. In this manner, dental products can be produced automated with high precision, as well as economically.

In some cases of applications it can be required that the impression prior to scanning is divided into several layers, which are then individually scanned, whereby the scan results of the individual layers are assembled with so-called matching software. Thus, from the data of these layers a virtual model is created, which is used for the production of a dental product.

An important advantage of the method in accordance with the invention lies therein, that in part, even conventional impression materials can be used for the negative mold, which are then scanned after being roughened. As each dentist is familiar with handling impression masses, no new techniques are required to be learned and no special devices must be introduced.

Moreover, the problem on which the invention is based is also solved by a special, optically scannable impression material, which is suitable for the production of a mold of at least one tooth or tooth stump, whereby the impression material contains 0.01 to 80 percent by weight titanium dioxide, zirconium dioxide, zinc oxide and/or barium sulfate. Thereby the impression material can essentially be a known irreversibly cross-linking material that is elastically ductile in hardened condition. Particularly suitable are alginates, condensation-cross-linking and addition-cross-linking silicones, addition-cross-linking aciridino-polyethers, addition-cross-linking silico-polyethers, condensation-cross-linking alkoxy-silyl-polyethers, polysulfides, as well as polyethers or silicones that are cross-linking via metatheses reaction. Particularly suitable is the impression material Panasil® made by Kettenbach GmbH & Co. KG. It was found that the scan result can be further improved when the impression material contains approximately 0.1 to 70 percent by weight, particularly 1 to 20 percent by weight and most preferred approximately 2 to 15 percent by weight titanium dioxide, zirconium dioxide, zinc oxide and/or barium sulfate. According to a preferred embodiment, the impression material contains at least 10 percent by weight titanium dioxide, zirconium dioxide, zinc oxide and/or barium sulfate.

The substances mentioned above brighten the impression material, whereby too much brightening can lead to contrasts that are too weak to some extent. Therefore, it is preferred when the mold material contains especially black pigments, coloring agents applied to a carrier material and/or oil and/or polymer-soluble coloring agents. As a result of this, for example, a gray tinting of the negative mold is achieved, which is particularly suited for optical scanning.

The pigments mentioned above, which improve the scannability of the impression mass by brightening and improve a change in contrast, can be combined with conventional strengthening and non-strengthening filler substances.

The pigments within the framework of the present invention are practically insoluble inorganic and organic coloring agents that have a refraction index of equal to or greater than 1.7.

By a filler substance within the framework of the present invention one understands a substance which influences the characteristics of the impression material with respect to hardness, density, elasticity and extension, and has a refraction index that is smaller than or equal to 1.7. Thereby, these can be strengthening filler substances or non-strengthening filler substances or mixtures of such.

Particularly highly dispersed, active filler substances with a BET surface of at least 50 m²/g, are particularly suited as strengthening filler substances. Especially suitable are those with individual particle size in the nanometer range, which can be present as aggregates and/or agglomerates. Preferred strengthening filler substances are substances selected from the group consisting of aluminum hydroxide, aluminum oxide, calcium carbonate and calcium sulfate, silicium dioxide, silicate such as talc, clay and glimmer, as well as precipitated and/or pyrogeneous silicilic acid. Of course, the previously mentioned compounds can be used individually or in any previously mentioned combination, and also in hydrophilic as well as in hydrophobic form.

In principle, as non-strengthening filler agents, the same substances are suitable as those for strengthening filler substances, whereby the non-strengthening substances, however, must absolutely have a BET surface of less than 50 m²/g (Publication Series Pigments Degussa Silicilic Acids, Number 12, Page 5, as well as Number 13, Page 3). Preferred, non-strengthening filler agents are substances that are selected from a group consisting of earthy base metal oxides, earthy base metal hydroxides, earthy base metal fluorides, earthy base metal carbonates, calcium apatite (Ca₅[(F, CL, OH, ½CO₃|(PO₄)₃], particularly calcium hydroxylapatite (Ca₅[OH, |(PO₄)₃], aluminum hydroxide, aluminum oxide, silicium dioxide, precipitated silicilic acid and calcium carbonate. Of course, the above mentioned compounds and be used individually or in any combination, and in hydrophilic as well as in hydrophobic form.

In a preferred embodiment, the impression material according to the invention is present on the basis of alginates, condensation-cross-linking and/or addition-cross-linking silicones, addition-cross-linking aciridino-polyethers, addition-cross-linking silico-polyethers, condensation-cross-linking alkoxy-silyl-polyethers, condensation-cross-linking polysulfides, as well as polyethers cross-linking as a result of metatheses reactions and/or silicones cross-linking as a result of metatheses reactions, and has pigments in the form of a combination of contrast-providing pigments and brightening pigments, whereby the latter contain titanium dioxide, zinc oxide, barium sulfate and/or preferably zirconium dioxide.

In a particularly preferred embodiment, the impression material according to the invention is present in the form of a 2-component dental impression material on the basis of addition-cross-linking silicones with components A and B. Thereby, component A contains an organopolysiloxane with at least two groups that are unsaturated with respect to ethylene and a hydrosilylation catalyst and component B contains an organohydrogenpolysiloxane. Further, components A and/or B contain pigments in the form of a combination of contrast-providing pigments and brightening pigments, whereby the latter contain titanium dioxide, zinc oxide, barium sulfate and/or preferably zirconium dioxide.

The organopolysiloxane with at least two groups that are unsaturated with respect to ethylene are preferably a polydimethylsiloxane containing vinyl, which can perhaps be present in the form of a mixture of various polydimethysiloxanes containing vinyl. The viscosity of the organopolysiloxanes is usually less than 180,000 mPa s at 20° C., preferably between 20 and 165,000 mPa s at 20° C.

The hydrosilylation catalyst is preferably a platinum catalyst.

The organohydrogenpolysiloxane is preferably a polymethylhydrogensiloxane which can, perhaps be present in a mixture of various polymethylhydrogensiloxanes. Used are organohydrogenpolysiloxanes with a Si—H content of 0.01 to 15 mmol/g.

As brightening pigments, preferably pigments are used that have an intentionally added trace and/or surface layer of titanium dioxide, zinc oxide, barium sulfate and/or zirconium dioxide, and which are inorganic white pigments in the form of metal oxides, metal hydroxides, metal oxyhydrates, metal carbonates, metal silicates or metal sulfates of the metals magnesium, calcium, strontium, barium, boron, aluminum, silicium, titanium, zinc. These brightening pigments were intentionally introduced during the production process with titanium dioxide, zinc oxide, barium sulfate and/or preferably zirconium dioxide and/or were provided with a surface layer of titanium dioxide, zinc oxide, barium sulfate and/or preferably zirconium dioxide.

The proportion of brightening pigments in the dental impression mass according to the invention is between 10 to 80 percent by weight, preferably 15 to 80 percent by weight in relationship to the dental impression mass.

As contrasting pigments, pigments are used that are dark in color, preferably black or black-gray. Preferably, these are dark colored pigments that are selected from the group of metals, carbons, particularly soot and/or graphites, metal oxides, metal hydroxides, metal oxyhydrates, metal silicates, sulfur-containing metal silicates, metal sulfides, metal cyanides, metal selenides, metal chromates, metal molybdates, as well as insoluble organic coloring agents or—made insoluble by lacquering—or organic coloring agents applied to inorganic pigments. These contrast-providing pigments are to be used in such a form, for example, in a sufficiently dimensioned grain size or a suitable grain form so that the desired contrast-enhancing effect is achieved.

The proportion of contrast-providing pigments in the dental impression mass according to the invention is less than 1 percent by weight, preferably less than 0.1 percent by weight and especially preferred between 0.0001 to 0.01 percent by weight in relationship to the dental impression mass.

Particularly preferred brightening pigments have a stabilization and/or surface layer of zirconium dioxide.

Preferred are impression materials that have a proportion of at least 10 percent by weight of contrast-providing pigments, particularly of at least 15 percent by weight related to the total mass of the dental materials.

The impression materials according to the invention preferably have a combination of contrast-providing pigments and brightening pigments that are chosen in such a way that the impression materials in hardened condition—upon examination with the CEREC measuring system—show brightness values of >90 percent and contrast values of >90 percent, measured compared to the reference material zirconium dioxide.

In a further preferred embodiment, the impression materials according to the invention have a combination of contrast-providing pigments and of brightening pigments that are selected in such a way that the impression materials in an examination with the L*a*b* color measuring system—in hardened condition—show L values of >80, preferably >85, particularly >90, and in examinations of scannability with the CEREC measuring system—in hardened condition—brightness values of >90 percent, as measured compared to the reference material zirconium dioxide.

The impression material in accordance with the invention is preferable used for the production of dental products such as bridges, crowns or tooth prostheses, and is especially preferred as bite registration material. The invention also concerns these uses.

In the following, the invention is described in further detail with the help of examples of embodiments and by referring to the drawing. In this process, all described and/or pictorially represented characteristics are by themselves, or in any combination, subject matter of the invention, independent of their summary in the claims or their reference.

The single FIGURE shows a comparison of the clearance and weights of soft probes that were produced by a conventional method (Comparative Example 1) and as per the method according to the invention as per Example 1.

### COMPARATIVE EXAMPLE 1

### Production of an Inlay by Intraoral Scanning with the CEREC 3 System®

A model was created from a standard preparation of a Frasaco tooth (tooth 36, Frasaco GmbH), and scanned with the CEREC 3 System® (Sirona Dental Systems GmbH) after the standard preparation was sprayed with Dentaco Scannspray (Dentaco Dentalindustrie und Marketing GmbH).

A two-surface inlay was designed from this virtual model that was prepared according to this method and shaped with a Mark II ceramic blank (VITA Zahnfabrik H. Rauter GmbH & Co. KG). Respectively, five soft probes were produced from the inlay, by filling the cavity with Panasil® contact plus (Kettenbach GmbH & Co. KG) and the inlay was inserted into the filled cavity. The soft probes thus reflected the space remaining between the inner wall of the cavity and the outer wall of the inlay, which is a measurement of the precision of the inlay.

These soft probes were poured into plastic (PalaXpress®, Heraeus Kulzer GmbH) and subsequently polished horizontally and vertically at various levels. These levels were measured under a microscope. Moreover, from the weight of the soft probes, the clearance volume was calculated. Hereby, a clearance width of 90 μm and a clearance volume of 7.67 mm³ was achieved.

### Example 1 (According to the Invention)

### Production of an Inlay by Scanning a Negative Mold with a Modified CEREC 3 System®

From the same standard preparation of a Frasaco tooth (tooth 36, Frasaco GmbH) as in Comparative Example 1, an impression was made with the impression material according to the invention based on impression material Panasil® (Kettenbach GmbH & Co. KG).

The surface of this impression was matted with a powder blasting jet process (e.g. Prophyflex Kavoprophypearls, KaVo Dental GmbH) for 30 seconds. Subsequently, this negative form was scanned with a modified CEREC 3 System®(Sirona Dental Systems GmbH), whereby the software was modified in such a way that instead of projecting spots, impressions could be scanned.

As in Comparative Example 1, from the virtual model created in this manner, a two-surface inlay was designed and ground out of a Mark II ceramic blank (VITA Zahnfabrik H. Rauter GmbH & Co. KG). From the inlay in turn, five soft probes were produced by filling the cavity with Panasil® contact plus (Kettenbach GmbH & C. KG) and the inlay was inserted into the filled cavity.

The soft probes were poured into plastic (PalaXpress®, Heraeus Kulzer GmbH) and subsequently polished and measured horizontally and vertically at various levels. The clearance width was 77 μm and the clearance volume was 7.50 mm³.

As a result it could be seen that the optical scans of the impression with the camera of the CEREC 3 System® generated very precise results. At the same time, sources of errors that can occur during intraoral scanning are circumvented.

### Example 2 (according to the invention) and Comparative Example 2 to 4

The components used in Example 2, according to the invention, that are required for scannability, have the following characteristics:

a.) ZrO₂-coated titanium dioxide

| | |
|---|---|
| TiO₂ content | 94% |
| inorganic subsequent treatment | zirconium dioxide |
| particle size | .24 μm |
| specific weight | 4.05 g/cm³ |
| loss at 105° C. | .6% |
| pounding weight | 1.2 g/cm³ |
| oil number (g/100 g pigment) | 18 |
| water requirement (cm³/100 g pigment) | 28 |

b.) Color batch black

| | |
|---|---|
| chemical characterization | graphite powder suspended at |
| | 20% in silicon polymers |
| particle size | <20 μm |
| form | paste-like |
| color | black, L*: 3.47, a*: .22, b*: .08 |
| melting point/melting range | −50° C. |
| boiling point/boiling range | >200° C. |
| flashpoint | 210° C. (DIN 51376) |
| ignition temperature | 480° C. (DIN 51794) |
| steam pressure | at 20° C. approx. 5 hPa, at 50° C. |
| | approx 18 Pa |
| density | at 20° C. approx. .98 g/cm³ |
| viscosity 23° C. | dynamic 14,000-36,000 mPa s |
| | (Haake/Brookfield) |

### Example 2

### Scannable Bite Registration Material (According to the Invention)

### Catalyst Paste

In a closed kneader, 53 parts of the finest powder of cristobalite with a midsized grain of 7 μm, 3 parts of a pyrogeneously produced, highly dispersed hydrophobic silicic acid with a BET surface of 150 m²/g, 0.3 parts zeolith (molecular sieve), 15 parts ZrO₂-coated TiO₂ with a particle size of 0.24 μm, 25 parts divinylpolydimethylsiloxane with a viscosity of 50 mPa s, measured at 20° C., 2.5 parts trimethylsiloxypolydimethylsiloxane, 0.6 parts platinum catalyst and 0.1 part of a fatty alcohol-ethoxylate are homogenized for 2 hours and subsequently freed of gas in vacuum.

A white paste (ISO 4823) of medium viscosity was obtained. The paste represented component A of the two-component silicon material according to the invention. After storage at 60° C. for a month, the viscosity and reactivity were in the target range.

### Base Paste

In a closed kneader, 53 parts of the finest powder of cristobalite with a mid-sized grain size of 7 μm, 2.5 parts of a pyrogeneously produced, highly dispersed hydrophobic silicic acid with a BET surface of 150 m²/g, 0.06 parts of the color batch black, 15 parts ZrO₂-coated TiO₂ with a particle size of 0.24 μm, 20.5 parts divinylpolydimethylsiloxane with a viscosity of 50 mPa s, measured at 20° C., 7 parts polymethylhydrogensiloxane with a viscosity of 50 mPa s measured at 20° C., 2 parts trimethysiloxypolydimethlsiloxane and 0.15 parts of a fatty alcohol-ethoxylate are homogenized for 2 hours and subsequently freed of gas in a vacuum.

A white paste (ISO 4823) of medium viscosity was obtained. The paste represented component B of the two-component silicon material according to the invention. After storage at 60° C. for a month, the viscosity and reactivity were in the target range.

### Mixture

50 parts of components A and B were pushed out of a cartridge (made by the company Mixpac) and homogeneously mixed in a static mixer (from Mixpac).

At room temperature, the product could be processed for approximately 15 seconds and at a temperature of 35° C. it hardened within 60 seconds after the start of mixing.

As vulcanizer, white, hard, molds that were difficult to compress were obtained, but which were, however very easy to cut.

The color of the bite registration material was examined according to the CIELAB method with a Konica Minolta color measuring system and evaluated with the CEREC camera system for scannability. The results are presented in Table 1.

This example shows that the use of titanium dioxide coated with zirconium dioxide in combination with a contrast-providing dark-colored pigment leads to values in contrast brightness and dynamic that are very close to the reference material ZrO₂, and thus lead to excellent scannability in the CEREC system.

### Comparative Example 2

### Bite Registration Material Metalbite® Made by the Company R-Dental (not According to the Invention)

A commercial bite registration material Metalbite® made by the company R-Dental (lot 6403750) on the basis of addition-cross-linking vinyl polysiloxanes was mixed according to the manufacturer's instructions and left to set.

At room temperature, the product could be processed for approximately 30 seconds and at a temperature of 35° C. it hardened completely in approximately two minutes after the start of mixing.

The bite registration material was examined with respect to color with the CIELAB method with a Konica Minolta color measuring system and evaluated for its scannability with the CEREC camera system. The results are presented in Table 1.

This example shows that by using metal pigments a good contrast can be achieved, but it leads to a relatively significant loss of brightness and dynamic and thus to unfavorable results when scanning with the CEREC camera.

### Comparative Example 3

### Bite Registration Material Stonebite Scan® Made by the Company Dreve (not According to the Invention)

A commercial bite registration material Stonebite Scan® made by Dreve (lot. 602143/602147) on the basis of addition-cross-linking vinyl-polysiloxanes was mixed according to the manufacturer's instructions and left to set.

At room temperature, the product could be processed for approximately 30 seconds and at a temperature of 35° C. it hardened completely within approximately two minutes after the start of mixing.

The color of the bite registration material was examined according to the CIELAB method with a Konica Minolta color measuring system, and its scannability was assessed with the CEREC camera system. The results are presented in Table 1.

This example shows that although gray coloring achieves a very good contrast, it leads to a relatively significant loss of brightness and dynamic and thus to unfavorable results when scanning with the CEREC camera.

### Comparative Example 4

### Bite Registration Material Vanilla Bite®, Made by the Company Discus Inc. (not According to the Invention)

A commercial bite registration material not intended for scanning, Vanilla Bite® from Discus Inc. (lot. 6068001) on the basis of addition-cross-linking vinyl-polysiloxanes was mixed according to manufacturer's instructions and left to set.

At room temperature, the product could be processed for approximately 30 seconds and at a temperature of 35° C. it hardened completely within approximately two minutes after the start of mixing.

The color of the bite registration material was examined according to the CIELAB method with a Konica Minolta color measuring system and assessed for scannability with the CEREC camera system. The results are presented in Table 1.

This example shows that a white bite registration material that is not intended for scanning can achieve a certain brightness in the L*a*b* color measurement, which is a prerequisite for scannability, however, when scanning with the CEREC camera system, no contrast can be created, which leads to an unfavorable result when scanning.

### Measuring Methods/Measuring Device

The product was measured with a CEREC 3 camera (from the company Sirona) with respect to a CEREC-ZrO₂-standard from Sirona. For this, a test body with the measurements 4.8/16.9/19.4 mm was created and inserted into a camera attachment, whereby a precisely specified distance is defined between the surface and the scan camera.

The material was measured with Sirona software version 2.80 R228015 CEREC InLab.

As result, three parameters were specified, namely, brightness, contrast and the dynamic, whereby the dynamic is calculated using the product of contrast and brightness and dividing it by one hundred.

The result thus provides information about the scannability of the material, or its surface, whereby values of 100 percent for contrast, brightness and dynamic represent optimal scannability.

TABLE 1
Comparison of Scan Results
Reverence ZrO₂ → Contrast 100/Brightness 100/Dynamic 100

| | Contrast¹⁾ | Brightness¹⁾ | Dynamic¹⁾ | L*_{^{—}}²⁾ | a*_{^{—}}²⁾ | b*_{^{—}}²⁾ |
|---|---|---|---|---|---|---|
| Example 2 | 91.9 | 94 | 86.4 | 94.36 | −.47 | 1.42 |
| (according to the invention) | | | | | | |
| Comparative Example 2 | 82.3 | 42.5 | 35 | 75.02 | −.63 | −1.09 |
| Comparative Example 3 | 97.3 | 62.8 | 61.1 | 84.91 | −.42 | −1.15 |
| Comparative Example 4 | 3.26 | 76.84 | 2.5 | 91.12 | −1.61 | −6.43 |

¹⁾measured compared to the CEREC zirconium dioxide standard with the CEREC 3 camera system with software version 2.8 R228014 CEREC InLab from Sirona.
²⁾Color value measured in reflection mode without shine components (SCE) with the Konica [Konoca] Minolta color measuring device spectrophotometer CM 3500d.

1. A method for producing a dental product, the method comprising:
creating an impression as negative mold of at least one tooth or tooth stump with an impression material,
roughening at least a part of the surface of the impression,
scanning the roughened impression as negative mold and
mechanically producing the dental product by using the scan result.

2. The method according to claim 1, wherein the roughening of the surface of the impression is performed by sand blasting and/or powder jet methods.

3. The method according to claim 1, wherein the roughening of the surface of the impression is performed by laser irradiation, splatter methods, evaporation and/or plasma methods.

4. The method according to claim 1 wherein the scanning of the roughened impression is performed contact-free.

5. The method according to claim 1 wherein the at least one tooth or tooth stump is molded after grinding (preparation).

6. The method according to claim 1 wherein in the mechanical production of the dental product by using the scan results, a sample of a dental product is selected from a database and produced.

7. The method according to claim 1, wherein that the mechanical production of the dental product is performed by a CAD and/or a CAM process.

8. The method according to claim 1, wherein the impression is divided into several layers prior to scanning, which are then individually scanned, whereby the scanner results of the individual layers are assembled by software.

9. (canceled)

10. The method according to claim 1, wherein the impression material is used as a bite registration material.

11. A scannable impression material for producing an impression of at least one tooth or tooth stump, wherein the impression material contains 0.01 to 80 percent by weight titanium dioxide, zirconium dioxide, zinc oxide and/or barium sulfate, as well as one or more black pigments, coloring agents applied to a carrier material and/or oil and/or polymer-soluble coloring agents.

12. The impression material according to claim 11, wherein the impression material contains 0.1 to 70 percent of weight titanium dioxide, zirconium dioxide, zinc oxide and/or barium sulfate.

13. The impression material according to claim 11, wherein the impression material contains at least 10 percent by weight titanium dioxide, zirconium dioxide, zinc oxide and/or barium sulfate.

14. An impression material, comprising:
a base of one or more alginates, condensation-cross-linking and/or addition-cross-linking silicones, addition-cross-linking aciridino-polyethers, addition-cross-linking silico-polyethers, condensation-cross-linking alkoxysilyl-polyethers, condensation-cross-linking polysulfides, cross-linking polyethers via metatheses reaction or cross-linking silicones via metatheses reaction; and
pigments in the form of a combination of contrast-providing pigments and brightening pigments, the brightening pigments containing titanium dioxide, zinc oxide, barium sulfate and/or zirconium dioxide.

15. The impression material according to claim 14, wherein the impression material is present in the form of a 2-component dental impression material on the basis of addition-cross-linking silicones with components A and B, wherein contained in component A is an organopolysiloxane with at least two groups that are unsaturated with respect to ethylene or a hydrosilylation catalyst, contained in component B is an organohydrogenpolysiloxane and contained in component A and/or B are pigments in the form of a combination of contrast-providing pigments and brightening pigments, the brightening pigments containing titanium dioxide, zinc oxide, barium sulfate and/or zirconium oxide.

16. The impression material according to claim 14 wherein the brightening pigments are inorganic white pigments in the form of metal oxides, metal hydroxides, metal oxyhydrates, metal carbonates, metal silicates or metal sulfates of the metals magnesium, calcium, strontium, barium, boron, aluminum, silicium, titanium, zinc, that were intentionally introduced during the production process with titanium dioxide, zinc oxide, barium sulfate and/or zirconium dioxide and/or were provided with a surface layer of titanium dioxide, zinc oxide, barium sulfate and/or zirconium dioxide.

17. The impression material according to claim 14, wherein the contrast-providing pigments are dark in color and are selected from the group consisting of metals, carbons, metal oxides, metal hydroxides metal oxyhydrates, metal silicates, sulfur-containing metal silicates, metal sulfides, metal cyanides, metal selenides, metal chromates, metal molybdenates, non-soluble organic coloring agents, organic coloring agents made insoluble by lacquering, and organic coloring agents applied to inorganic pigments; and the contrast-providing pigments are used in a proportion of less than 1 percent by weight with respect to the dental impression mass.

18. The impression material according to claim 14, wherein the brightening pigments are intentionally laced with and/or have a surface layer of zirconium dioxide and are used in a proportion of at least 10 to 80 percent by weight with respect to the total mass of the dental material.

19. The impression material according to claim 14, wherein in an examination with the CEREC measuring system, in hardened condition, the impression material has brightness values of >90 percent and contrast values of >90 percent, as measured compared to the reference material, zirconium dioxide.

20. The impression material according to claim 14, wherein in an examination with the L*a*b* color measuring system, in hardened condition, the impression material has L values of >80, and in examinations of the scannability with the CEREC measuring system, in hardened condition, the impression material has brightness values of >90 percent and contrast values of >90 percent as measured compared to the reference material zirconium dioxide.
